(19) United States
(12) Patent Application Publication
(10) Pub. No.: US 2023/0041559 A1
(43) Pub. Date: Feb. 9, 2023

(54) APPARATUS AND METHODS FOR MULTIFACTOR AUTHENTICATION

(71) Applicant: Bank of America Corporation, Charlotte, NC (US)

(72) Inventors: Patrick Burgess, Stockholm (SE); Trish Gillis, Chicago, IL (US); Taylor Farris, Hoboken, NJ (US); Napangsiri Wanpen, New York, NY (US)

(21) Appl. No.: 17/392,436

(22) Filed: Aug. 3, 2021

(51) Int. Cl. H04W 12/06; H04W 12/63

(52) U.S. Cl. CPC H04W 12/06; H04W 12/63

(57) ABSTRACT

Apparatus and methods for multifactor authentication using a smart mobile device are provided. The apparatus and methods may include an authentication engine on a server, a smart mobile device belonging to a user and a smartphone belonging to a user. The authentication engine may determine a location of the user, the user's smartphone, and the user's smart mobile device. When the smart mobile device is within a pre-determined distance to the user or the user's smartphone, the authentication engine may send an authentication request to the smart mobile device, or automatically authenticate the user.

### FIELD OF TECHNOLOGY

Aspects of the disclosure relate to providing apparatus and methods for multifactor authentication of a user with a smart mobile device.

### BACKGROUND OF THE DISCLOSURE

Smartphones are ubiquitous today. Other smart mobile devices, such as smartwatches, fitness trackers, smartcards, tablets, and smart glasses, may integrate some of the functions of smartphones in different and various form factors. These other smart mobile devices are also becoming more ubiquitous, even if they have not achieved the same level of popularity as smartphones.

Many software applications (smartphone app-based as well as browser/desktop app-based) require a user to login and authenticate before use, as a single-factor authentication (e.g., a username and password). A large subset of these software applications also require further authentication to use certain features of the applications. For example, in order to make an in-app purchase, a user will generally be required to re-login or authenticate themselves before the purchase will be approved. In another example, financial institution applications will often require a one-time password and/or re-authentication before approving a transfer of money from a user's account to another account.

Generally, these options may require multiple extra steps by the user, taking extra time as well as causing discontent and annoyance among users, which may cause the user(s) to cancel purchases and reduce their use of the application(s). Reducing the number of steps by utilizing smart mobile devices for multi-factor authentication may save time and prevent users from cancelling purchases and deleting the application(s).

In addition, properly configured smart mobile devices may be able to provide similar levels of security and authenticity as one-time passwords, regular passwords and other standard security and authentication methods. Unique serial numbers and MAC addresses that may be encrypted may be more secure than regular passwords as they may be of longer length and randomized.

Therefore, it would be desirable for apparatus and methods to enable multifactor authentication using smart mobile devices instead of standard security and authentication methods.

### SUMMARY OF THE DISCLOSURE

It is an object of this disclosure to provide apparatus and methods for multifactor authentication through smart mobile devices.

An apparatus for multi-factor authentication is provided. The apparatus may include a central server and a smart mobile device belonging to a user. In an embodiment, the central server may be distributed, to utilize a larger pool of computing resources and provide redundancy.

The server may include a communication link, to enable communication with the smart mobile device and other computers/servers as needed.

The server may include a processor or processors, as well as non-transitory memory.

The non-transitory memory may include an operating systems as well as an authentication engine/program/module that runs on the processor. In an embodiment, the non-transitory memory may include data, in a database or otherwise, to allow the authentication engine to authenticate a particular user.

The authentication engine may receive a request to authenticate the user from a software application or approve a particular interaction in the application by a user already authenticated by the application. The authentication engine may then query the application to discover where the user is located. For example, the authentication engine may use an IP address or GPS location to locate the user. The authentication engine may also query the smart mobile device to discover its location. In an embodiment, the authentication engine may only determine if the user is located near the smart mobile device, without necessarily determining either the user's or the smart mobile device's location relative to the globe.

When the authentication engine determines that the user and the smart mobile device are located near each other, the engine may transmit an authentication request to the smart mobile device and prompt the user to approve the authentication request. Once the user approves the request, that approval may be sent back to the authentication engine, which may then approve the originally requested interaction or authentication. In an embodiment, the authentication engine may determine that the user and smart mobile device are located near each other if they are within three feet of each other, as three feet may be approximately the average distance between a user's core and the user's wrist.

In an embodiment, the smart mobile device may be a smartwatch.

In an embodiment, the apparatus may include a smartphone belonging to the user, and in an embodiment, the application the user is interacting with may be running on the smartphone. For example, the user may be attempting to make an ‘in-app purchase’ (“TAP”) while using a particular application on her smartphone. To authenticate and approve the IAP, the application may require the user to re-authenticate or provide some further form of authentication. The apparatus and methods provided herein may be an alternative form of this multi-factor authentication requirement.

In an embodiment, the smart mobile device may include a biometric scanner. Biometric scanners may include facial recognition, fingerprint scanners, iris/retinal scanners, and other physical and behavioral biometric scanners.

In an embodiment, if the authentication engine determines that the user and smart mobile device are not located near each other, the authentication engine may default/revert to the standard authentication protocol(s) and method(s) and send the authentication request back to the application.

An apparatus for multi-factor authentication is provided. The apparatus may include a central server, a smartphone belonging to a user, and a smart mobile device also belonging to the user. In an embodiment, the server may be distributed.

The server may include a communication link to allow the server to communicate with the smartphone, smart mobile device, and other computers and peripherals. The server may include a processor or processors as well as non-transitory memory.

The non-transitory memory may store data enabling authentication of the user, an operating system, and an authentication engine/program/module.

The authentication engine may receive a request to authenticate the user. The request may be sent from a remote software application or remote device, including mobile devices as well devices such as building security locks. The authentication engine may then query the locations of the smartphone and the smart mobile device.

When the smart mobile device and smartphone are located near other (i.e., within a pre-determined distance from each other), the authentication engine may send an authentication request to both the smartphone and the smart mobile device. The engine may then prompt the user to confirm one or both of the requests. Requiring both authentications may increase security. Once the user has confirmed, the confirmation may be sent to and received by the authentication engine. Once the confirmation has been received, the authentication engine may authenticate the user as requested.

In an embodiment, the smart mobile device may be a smartwatch. In an embodiment, the smart mobile device may be a smartcard (i.e., a card with the form factor of a credit card, but with a processor, memory, screen, battery, and other components that allow the smartcard to perform functions typically reserved for smartphones and other smart mobile devices).

In an embodiment, the smart mobile device may include a biometric sensor. In an embodiment, the user may approve or confirm the authentication request by activating the biometric sensor (such as a fingerprint scanner or facial recognition).

In an embodiment, the authentication engine may determine that the smartphone and smart mobile device are near other if they are within three feet of each other (i.e., the pre-determined distance is three feet or less).

In an embodiment, the smartphone and smart mobile device may be wirelessly connected to each other. Wireless connections may be formed over wi-fi, Bluetooth, near-field communication (NFC), or other appropriate apparatus and methods.

In an embodiment, the pre-determined distance may be a function of the type of wireless connection between the smartphone and smartwatch. For example, the pre-determined distance may only be a few inches if the two devices are connected over NFC, or a few feet if connected over Bluetooth.

In an embodiment, as long as the two devices are connected over an approved connection, the authentication engine may consider them to be located near each other. This may increase security or decrease security depending on the connection type. For example, wi-fi connections may be available significantly further than Bluetooth or NFC connections. The permissibility of the connection allowable for authentication may be determined by the request, and what the request is attempting to secure/authenticate. (For example, a request to authenticate a user before transferring a large sum of money may require more robust authentication than a request to make an IAP for 0.99$.)

A method for multi-factor authentication is provided. The method may utilize a smart mobile device belonging to a user. The method may include an authentication engine/program that runs on a central or distributed server. The method may include the authentication engine receiving a request to authenticate the user when the user is using/interacting with a software application.

The method may include the authentication engine querying the locations of the user and the smart mobile device. When the user and the smart mobile device are near each other (within a pre-determined distance), the authentication engine may send an authentication request to the smart mobile device. The request may be displayed on the screen of the smart mobile device. The method may include the authentication engine sending a signal to the device to prompt the user to approve the authentication request. In an embodiment, the prompt may be included with the authentication request (i.e., the request may emit a sound, a vibration, a light, etc. when it arrives, notifying the user to approve or disapprove the authentication request).

The method may include receiving a positive approval of the authentication request at the authentication engine and authenticating the user.

In an embodiment, the smart mobile device may be a smartwatch.

In an embodiment, the application requesting authentication of the user may be running on the user's smartphone. In this embodiment, the method may include the authentication engine querying the location of the user's smartphone, and the engine only transmitting the authentication request to the user's smart mobile device when it is within a pre-determined distance of the user's smartphone. For example, if the smart mobile device is a smartwatch, when it is within three feet of the smartphone, an approximately average distance between a user's wrist wearing a smartwatch and a pocket of the user where a smartphone could be located.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative diagram in accordance with principles of the disclosure.

FIG. 4 shows an illustrative apparatus in accordance with principles of the disclosure.

FIG. 5 shows an illustrative flowchart in accordance with principles of the disclosure.

FIG. 6 shows an illustrative flowchart in accordance with principles of the disclosure.

FIG. 7 shows an illustrative flowchart in accordance with principles of the disclosure.

### DETAILED DESCRIPTION OF THE DISCLOSURE

An apparatus for multi-factor authentication is provided. The apparatus may include a central server and a smart mobile device belonging to a user.

In an embodiment, the central server may be distributed, to utilize a larger pool of computing resources and provide redundancy. Centralized servers may be easier to secure but also provide a single failure point. Distributed servers may be more robust but may provide multiple avenues for malicious actors to target. A preferred embodiment may be a centralized server.

Smart mobile devices may be any smart computing device that is human portable or wearable with some functionality, but generally less functionality than a full-fledged smartphone. Typical examples may include a smartwatch, a fitness tracker, or a smartcard. Smart mobile devices may have a unique serial code or MAC address that when encrypted may be more robust than any password due to length and variety. Each smart mobile device may be registered to a particular user and the serial number or MAC address (encrypted and/or hash values) may be stored and associated with the particular user. In an embodiment, smart mobile devices may refer to wearable smart devices, such as smartwatches, fitness trackers, and smart glasses.

The server may include a communication link, to enable communication with the smart mobile device and other computers/servers as needed. The communication link may include any necessary hardware (e.g., antennae) and software to control the link. The server may utilize the communication link to communicate, over a network, with any application the user is interacting with or any application or hardware that is requesting authentication of the user. Any appropriate communication link may be used. In an embodiment, the network may be the Internet. In another embodiment, the network may be an internal intranet.

The server may include a processor or processors, as well as non-transitory memory. The non-transitory memory may include an operating systems as well as an authentication engine/program/module that runs on the processor. In an embodiment, the non-transitory memory may include data, in a database or otherwise, to allow the authentication engine to authenticate a particular user.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The processor(s) may control the operation of the apparatus and its components, which may include RAM, ROM, an input/output module, and other memory. The microprocessor may also execute all software running on the apparatus—e.g., the operating system and any applications such as the AI/ML authentication engine and any security protocols. Other components commonly used for computers, such as EEPROM or Flash memory or any other suitable components, may also be part of the apparatus.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology— e.g., a hard drive or other non-transitory memory. The memory may store software including an operating system and any application(s) (such as the authentication engine) along with any data needed for the operation of the apparatus and to allow authentication of a user. The data may also be stored in cache memory, or any other suitable memory. Alternatively, some or all of computer executable instructions (alternatively referred to as “code”) may be embodied in hardware or firmware.

An input/output (“I/O”) module may include connectivity to a keyboard, monitor, or network interface through which a user may provide input. The input may include input relating to cursor movement. The input/output module may also include one or more speakers for providing audio output and a video display device, such as an LED screen and/or touchscreen, for providing textual, audio, audiovisual, and/or graphical output.

The authentication engine may receive a request to authenticate the user from a software application or to approve a particular interaction in the application by a user already authenticated by the application. Alternatively, the request for authentication may come from a physical device, such as building security door lock. If the user has already been authenticated, but the software application is requesting further authentication or re-authentication, that second authentication may be referred to as secondary authentication or multifactor authentication. The software application may request secondary authentication when the user is interacting with the application and desires to perform an action that requires more security. Typical examples may include in-app purchases (“IAP”s) or financial transactions. Secondary authentication may increase security for interactions with applications and prevent malicious activity.

The authentication engine may then query the application to discover where the user is located. It may be assumed that the user is in the same location as the application (e.g., when the application is run on a smartphone, the user will typically be holding the smartphone or interacting with the smartphone directly). One way to query may be to send a ping to the application along with a request for location data, such as an IP address or GPS coordinates. In an embodiment, location data may be provided by cellular signals and cellular towers. Some location data may be more exact than other data. For example, GPS coordinates may be accurate to within a foot while IP addresses may be accurate to within 100 feet. In an embodiment, the authentication engine may use environmental awareness as part of its query. For example, the engine may use multiple cellular tower locations to triangulate the location of a smartphone or other device. In another example, the engine may utilize known locations of items (e.g., radar transmitters or radio receivers) and deduce the location of a user or smartphone from radio or other signals and the known location(s).

The authentication engine may also query the smart mobile device, in the same or a different manner as querying the location of the user, to discover its location. In an embodiment, the authentication engine may only determine if the user is located near the smart mobile device, without necessarily determining either the user's or the smart mobile device's location relative to the globe. In this embodiment, the engine may send instructions to the application to determine if the smart mobile device is located in a pre-determined proximity to the computer running the application. This may be done through wi-fi, Bluetooth, NFC, or other types of signals as appropriate. If it is located within the pre-determined distance, the authentication request may be automatically approved.

The authentication engine may then compare the locations of the user and the smart mobile device. When the authentication engine determines that the user and the smart mobile device are located near each other (i.e., within a pre-determined distance from each other), the engine may transmit an authentication request to the smart mobile device and prompt the user to approve the authentication request. In an embodiment, the authentication engine may require the user to tap a screen on the smart mobile device to approve the request. In an embodiment, the engine may require the user tap a checkbox (which may be green) to approve and may provide a X (which may be red) for the user to select if the user decides to not approve the authentication request. Other smart mobile devices may have the user approve the request through various other means, such as unique gestures, speaking, entering a PIN, a fingerprint, or other approval methods.

Once the user approves the request, that approval may be sent back to the authentication engine, which may then approve the originally requested interaction or authentication. In an embodiment, the authentication engine may determine that the user and smart mobile device are located near each other if they are within three feet of each other, as three feet may be approximately the average distance between a user's core and the user's wrist.

In other embodiments, the pre-determined distance may be different and may depend on how the user is interacting with the application (i.e., through a desktop computer, through a smartphone, etc.) and the type of smart mobile device. The pre-determined distance may also depend on the manner used to determine the location of the user and the smart mobile device. For example, certain signals have different accuracies. In an embodiment, if a particular manner to determine location is the only one available (e.g., an IP address), but that manner has an accuracy greater than the pre-determined distance; the authentication engine may determine that it is unable to authenticate the user.

In an embodiment, the pre-determined distance may vary depending on the authentication request and the level of security required. A higher level of security may require a shorter distance.

In an embodiment, the apparatus may also include one or more smartphones belonging to the user in addition to the smart mobile device belonging to the user.

In an embodiment, the application the user is interacting with may be running on the smartphone. This may be a preferred embodiment. For example, the user may be attempting to make an ‘in-app purchase’ (“TAP”) while using a particular application on her smartphone. Or the user may be interacting with a mobile banking application and desires to transfer money to a service provider. To authenticate and approve the TAP or money transfer, the application may require the user to re-authenticate or provide some further form of authentication. Many current applications will send a one-time passcode or pin number through text message or email that the user will be required to enter as their form re-authorization, even if the user has already logged into the application. The apparatus and methods provided in this disclosure may be an alternative form of this multi-factor authentication requirement.

In an embodiment, the smart mobile device may include a biometric sensor. Biometric scanners may include facial recognition, fingerprint scanners, iris/retinal scanners, and other physical and behavioral biometric scanners. Individual smart mobile devices may have one or more biometric scanners. In an embodiment, the authentication engine may activate the biometric sensor on the smart mobile device and the user may authenticate/approve the authentication request by using the biometric sensor.

In an embodiment, if the authentication engine determines that the user and smart mobile device are not located near each other, the authentication engine may default/revert to the standard authentication protocol(s) and method(s) and send the authentication request back to the application. In an embodiment, the authentication engine may decline authentication/authorization if the user and smart mobile device are not located near each other, or if the user and device move apart within a pre-determined time limit (e.g., 15 seconds while the IAP or transfer is approved).

An apparatus for authentication is provided. The apparatus may include a central server, a smartphone belonging to a user, and a smart mobile device also belonging to the user. In an embodiment, the server may be distributed. The server may include a communication link to allow the server to communicate with the smartphone, smart mobile device, and other computers and peripherals. The server may include a processor or processors as well as non-transitory memory. The non-transitory memory may store data enabling authentication of the user, an operating system, and an authentication engine/program/module.

The authentication engine may receive a request to authenticate the user. The request may be sent from a remote software application or remote device, including mobile devices as well devices such as building security locks. The authentication engine may then query the locations of the smartphone and the smart mobile device. The authentication request may be the initial request (i.e., the user is attempting to login to the application), or it may be a secondary request.

When the smart mobile device and smartphone are located near other (i.e., within a pre-determined distance from each other), the authentication engine may send an authentication request to both the smartphone and the smart mobile device. The pre-determined distance may vary depending on the type of smart mobile device as well as the manner in which the authentication engine determines if the smartphone and smart mobile device are near each other.

In an embodiment, simply the fact that the engine determines that the smartphone and smart mobile device are near each other would be enough to authenticate the user, and the user may not have to confirm authentication. As the smart mobile device and smartphone have been registered to the user, having both near other may be all that is required for the engine to authenticate. This may be a lower level of security but may be enough for certain applications or transactions. In an embodiment, the user may be alerted, through a notification or vibration, that authentication has been approved once the two devices have been placed close enough to each other.

The engine may then prompt the user to confirm one or both of the requests. In an embodiment, only one approval is necessary. For example, the user may tap a checkbox on a screen of the smartphone, or the user may decide to tap the screen of the smart mobile device (e.g., a smartwatch). The user may decide for herself which one is easier to approve. In another embodiment, both approvals may be necessary, to increase security as a form of multi-factor authentication.

Once the user has confirmed, the confirmation may be sent to and received by the authentication engine. Once the confirmation has been received, the authentication engine may authenticate the user as requested.

In an embodiment, the smart mobile device may be a smartwatch. In an embodiment, the smart mobile device may be a smartcard (i.e., a card with the form factor of a credit card, but with a processor, memory, screen, battery, and other components that allow the smartcard to perform functions typically reserved for smartphones and other smart mobile devices). Other smart mobile devices may be used as well, such as fitness trackers and smart glasses.

In an embodiment, the smart mobile device may include a biometric sensor. In an embodiment, the user may approve or confirm the authentication request by activating the biometric sensor (such as a fingerprint scanner or facial recognition). In other embodiments, other forms of approval/confirmation may be used, such as unique gestures, voiceprints, typing, or drawing a signature.

In an embodiment, the authentication engine may determine that the smartphone and smart mobile device are near other if they are within three feet of each other (i.e., the pre-determined distance is three feet or less). Three feet may be an optimal distance as the length of an average human arm is less than three feet. In various embodiments, the pre-determined distance may vary based on the method of determining location of the smartphone and smart mobile device, as some methods may be more accurate than others.

In an embodiment, the authentication engine may use artificial intelligence/machine learning (“AI/ML”) algorithm(s) to determine the required pre-determined distance. For example, the engine may learn that certain smart mobile devices can only provide a location accurate to within 10 feet, and if that is the only smart mobile device available, the pre-determined distance must be 10 feet. The engine may evaluate other factors, including, inter alia, the requirements included in the authentication request, the type of authentication request, the amount of money involved, past history of the user, and other factors to determine the allowable distance between the user, the smartphone, and/or the smart mobile device.

In an embodiment, the smartphone and smart mobile device may be wirelessly connected to each other. Wireless connections may be formed over wi-fi, Bluetooth, near-field communication (NFC), or other appropriate apparatus and methods.

In an embodiment, the pre-determined distance may be a function of the type of wireless connection between the smartphone and smartwatch. For example, the pre-determined distance may only be a few inches if the two devices are connected over NFC, or a few feet if connected over Bluetooth. The engine may determine that authentication with the smart mobile device is not possible because of the types of connections available, or other reasons.

In an embodiment, as long as the two devices are connected over an approved connection, the authentication engine may consider them to be located near other. This may increase security or decrease security depending on the connection type. For example, wi-fi connections may be available significantly further than Bluetooth or NFC connections. The permissibility of the connection allowable for authentication may be determined by the request, and what the request is attempting to secure/authenticate. (For example, a request to authenticate a user before transferring a large sum of money may require more robust authentication than a request to make an IAP for 1.99$.)

A method for multi-factor authentication is provided. The method may utilize a smart mobile device belonging to a user. The method may include an authentication engine/program that runs on a central or distributed server. Each of the central or distributed server setups may be appropriate in various situations, as they vary in cost, security, and processing power.

The method may include the authentication engine receiving a request to authenticate the user when the user is using/interacting with a software application. The software application may send a request to authenticate the user to the central server when the user logs into the application. In an embodiment, the application may send a request to authenticate the user when the user has already logged in, but the user desires to interact with the application in a manner that requires heightened security and authentication.

The method may include the authentication engine querying the locations of the user and the smart mobile device. The engine may query by sending a request for the device's location to the device, or sending a ping, or by calculating location through known environmental objects (such as cell towers), or through any other appropriate method.

When the user and the smart mobile device are near each other (within a pre-determined distance), the authentication engine may send an authentication request to the smart mobile device. In an embodiment, the physical locations of the devices may not be necessary, and the only knowledge necessary may be that the two devices are near each other within a pre-determined distance. In an embodiment, the only knowledge necessary for the engine to send an authentication request may be that the user is wearing the smart device.

The request may be displayed on the screen of the smart mobile device. In an embodiment, if the smart mobile device does not have a screen, the user may be notified of the request through a different method, such as a sound or vibration.

The method may include the authentication engine sending a signal to the device to prompt the user to approve the authentication request. In an embodiment, the prompt may be included with the authentication request (i.e., the request may emit a sound, a vibration, a light, etc. when it arrives, notifying the user to approve or disapprove the authentication request).

The method may include receiving a positive approval of the authentication request at the authentication engine and authenticating the user.

In an embodiment, simply the knowledge (to a particular degree of certainty, such as more likely than not, or 99% certainty) by the engine that the user is wearing the smart mobile device may be enough to authenticate the user, and no request need be sent or approved by the user (i.e., no extra authentication steps may be required). Using this knowledge alone to authenticate a user may save time and processing power, as well as provide convenience to a user. In an embodiment, the authentication engine may switch between using this knowledge (i.e., that the user is wearing the smart mobile device) alone to authenticate and requiring extra authentication steps depending on the authentication request and the type of authentication required. In an embodiment, the engine may use AI/ML algorithm(s) to make the determination as to what level of authentication may be needed, by taking into account various factors including, inter alia, the requirements of the authentication request, past history, and the details of the transaction or interaction contemplated by the user.

In an embodiment, the application requesting authentication of the user may be running on the user's smartphone or other device distinct from the smart mobile device (such as a tablet or laptop). In this embodiment, the method may include the authentication engine querying the location of the user's smartphone/device, and the engine only transmitting the authentication request to the user's smart mobile device when it is within a pre-determined distance of the user's smartphone/device, or within a certain proximity of the smartphone/device. For example, if the smart mobile device is a smartwatch, when it is within three feet of the smartphone/device, which may be an approximately average distance between a user's wrist wearing a smartwatch and a pocket of the user where a smartphone could be located.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

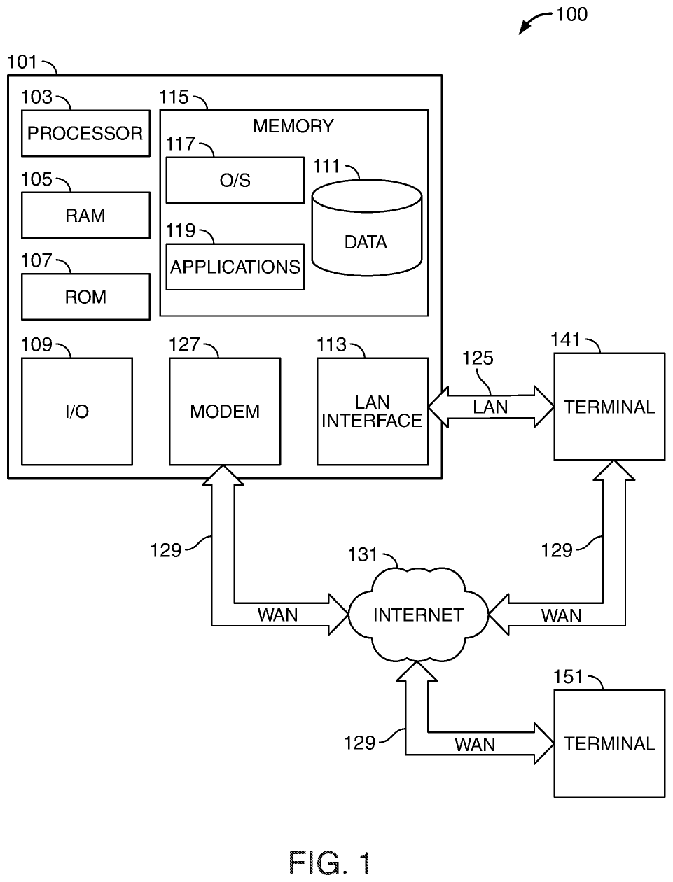

In accordance with principles of the disclosure, FIG. 1 shows an illustrative block diagram of apparatus 100 that includes a server 101. Server 101 may alternatively be referred to herein as a “computing device.” Elements of apparatus 100, including server 101, may be used to implement various aspects of the apparatus and methods disclosed herein. A “user” of apparatus 100 or server 101 may include other computer systems or servers, or a human.

Server 101 may have one or more processors/microprocessors 103 for controlling the operation of the device and its associated components, and may include RAM 105, ROM 107, input/output module 109, and a memory 115. The microprocessors 103 may also execute all software running on the server 101—e.g., the operating system 117 and applications 119 such as the authentication engine and security protocols. Other components commonly used for computers, such as EEPROM or Flash memory or any other suitable components, may also be part of the server 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as the authentication engine) along with any other data 111 (e.g., authentication profile(s) of a user and data regarding the user's mobile devices such as serial numbers or MAC addresses) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

In an embodiment of the server 101, the microprocessor 103 may execute the instructions in all or some of the operating system 117, any applications 119 in the memory 115, any other code necessary to perform the functions in this disclosure, and any other code embodied in hardware or firmware (not shown).

An input/output (“I/O”) module 109 may include connectivity to a keyboard, monitor, microphone, or network interface through which higher hierarchal server or a user of server 101 may provide input. The input may include input relating to cursor movement. The input/output module 109 may also include one or more speakers for providing audio output and a video display device, such as an LED screen and/or touchscreen, for providing textual, audio, audiovisual, and/or graphical output (not shown).

In an embodiment, apparatus 100 may consist of multiple servers 101, along with other devices.

Apparatus 100 may be connected to other systems, computers, servers, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, or servers that include many or all of the elements described above relative to apparatus 100. The network connections depicted in FIG. 1 include a local area network (LAN) 125 and a wide area network (WAN) 129 but may also include other networks. Server 101 may include a network interface controller (not shown), which may include a modem 127 and LAN interface or adapter 113, as well as other components and adapters (not shown). When used in a LAN networking environment, server 101 is connected to LAN 125 through a LAN interface or adapter 113. When used in a WAN networking environment, server 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for invoking user functionality related to performing various tasks. In an embodiment, application program(s) 119 may be cloud-based applications. In an embodiment, application program(s) 119 may be an authentication engine and/or security protocols. In an embodiment, the authentication engine may use AI/ML algorithm(s). The various tasks may be related to using smart mobile devices to enable authentication and multi-factor authentication of a user.

Server 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, smart mobile device, or any other suitable device for receiving, storing, transmitting and/or displaying relevant information. Terminal 151 and/or terminal 141 may be other devices such as remote servers. The terminals 151 and/or 141 may be computers where the user is interacting with the application that is being monitored by apparatus 100.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, server computers, hand-held or laptop devices, tablets, mobile phones, smart phones, smart mobile devices, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

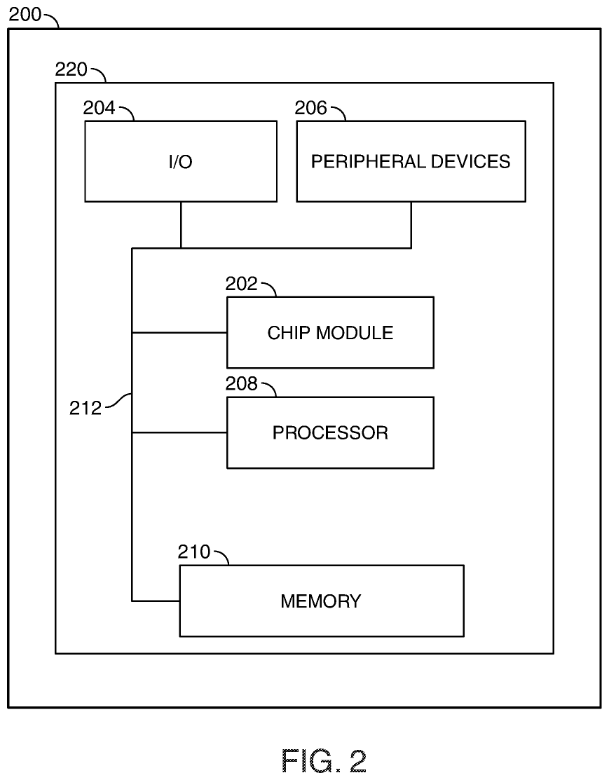

FIG. 2 shows illustrative apparatus 200 that may be configured in accordance with the principles of the disclosure. Apparatus 200 may be a smart mobile device or server with various peripheral devices 206. Apparatus 200 may include one or more features of the apparatus shown in FIGS. 1, 3, and 4. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an LED screen, a touchscreen or any other suitable media or devices; peripheral devices 206, which may include hands-free smart mobile devices; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

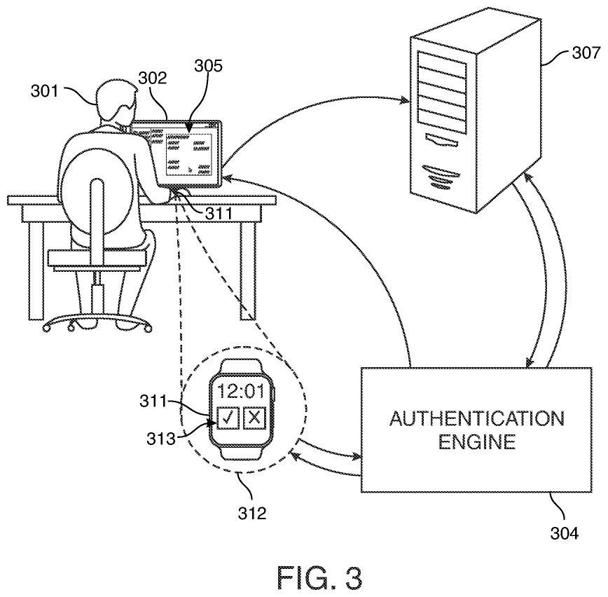

FIG. 3 shows an illustrative diagram in accordance with principles of the disclosure. A user 301 may interact with a software application 305 on a remote computer 302. The application 305 may communicate with remote server 307. The user 301 may be wearing smart mobile device 311. In an embodiment, smart mobile device 311 may be a smartwatch.

Magnification 312 is a magnification of smart mobile device/smartwatch 311 showing smart mobile device 311 in detail along with authentication request 313 on a screen of smart mobile device 311. An authentication engine 304 located on remote server 307 may receive a request to authenticate user 301 or authenticate an interaction user 301 wants to perform with application 305, after the user 301 has already been authenticated.

The authentication engine 304 may communicate with the smart mobile device 311 and application 305 to determine the locations of the user 301 and smart mobile device 311. When the user 301 and smart mobile device 311 are within a pre-determined distance of each other, authentication engine 304 may send an authentication request 313 to the smart mobile device 311 and communicate the results of the request (approval or disapproval) to the application 305. In an embodiment, the authentication engine 304 may skip sending authentication request 313 to smart mobile device 311 if it determines that proximity of the smart mobile device 311 to user 301 is enough authentication for purposes of the application 305.

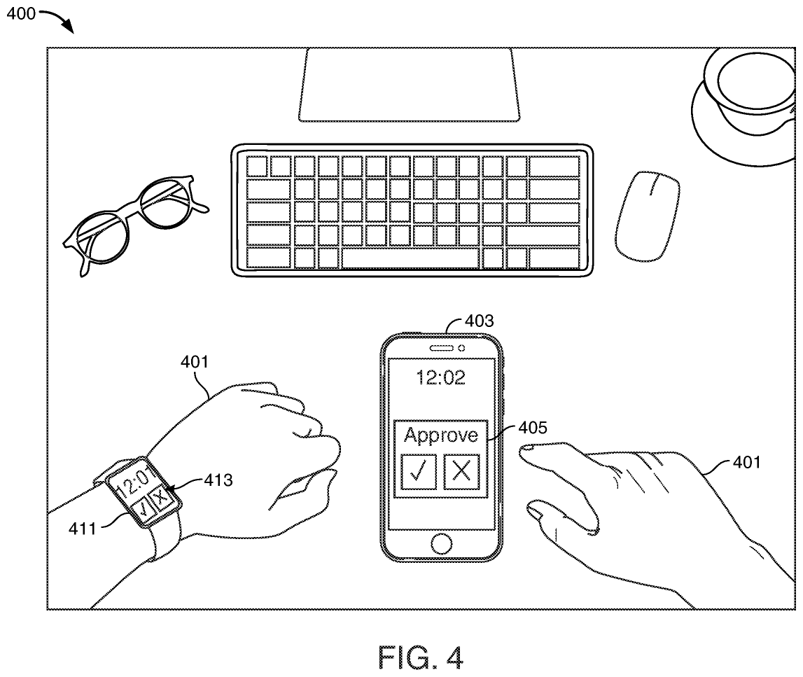

FIG. 4 shows an illustrative apparatus in accordance with principles of the disclosure. Work environment 400 may be a desk with various items on it. A user 401 may be wearing a smart mobile device 411. In an embodiment, smart mobile device 411 may be a smartwatch. The user 401 may also have a smartphone 403, which may be in the environment 400. In an embodiment, user 401 may receive an authentication request 405 on smartphone 403, while also receiving an authentication request 413 on smart mobile device 411. In an embodiment, the user 401 may choose to approve the request on either smartphone 403 or smart mobile device 411. In an embodiment, the authentication request 405 on smartphone 403 and the authentication request 413 on smart mobile device 411 may only be sent by an authentication engine (not shown) when the engine determines that smartphone 403 and smart mobile device 411 are in proximity with each other, as shown in environment 400.

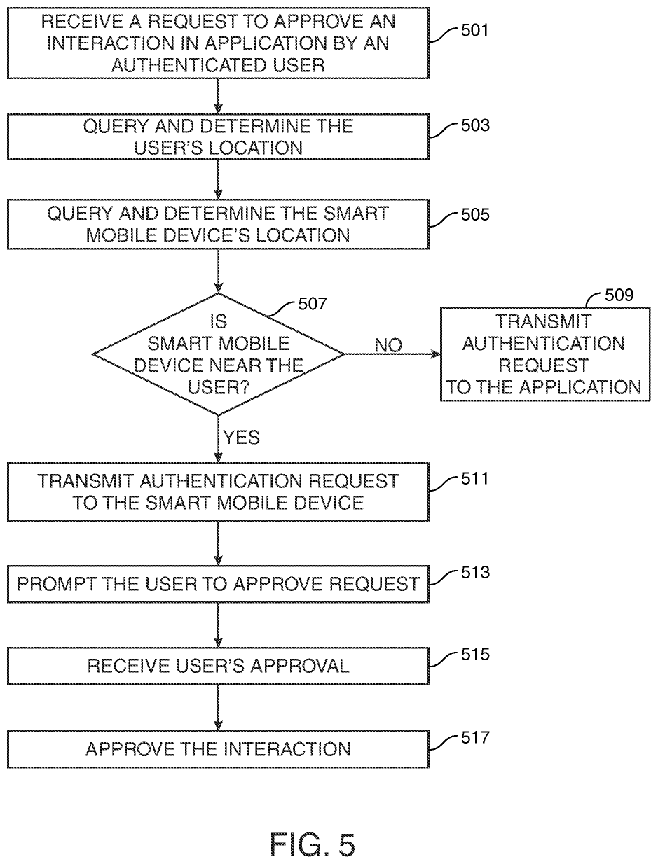

FIG. 5 shows an illustrative flowchart in accordance with principles of the disclosure. Methods may include some or all of the method steps numbered 501 through 517. Methods may include the steps illustrated in FIG. 5 in an order different from the illustrated order. The illustrative method shown in FIG. 5 may include one or more steps performed in other figures or described herein. Steps 501 through 513 may be performed on the apparatus shown in FIGS. 1-4, or other apparatus.

At step 501, an authentication engine may receive a request to approve an interaction in a software application by an already authenticated user. The request may come from the software application. The authentication engine may be located on a server, which may be centralized or distributed in various embodiments.

At step 503, the authentication engine may query and determine the user's location. The query may be sent to the application, as it may be assumed the user is in the same location as the application. At step 505, the authentication engine may query and determine the location of a smart mobile device belonging to the user.

At step 507, the authentication engine may determine if the smart mobile device is near the user, or within a pre-determined distance from the user. If not, at step 509 the authentication engine may only transmit the authentication request to the application and not send it to the smart mobile device.

If the smart mobile device is proximate to the user, at step 511, the authentication engine may transmit an authentication request to the smart mobile device for the user to approve or disapprove. At step 513, the authentication engine may prompt the user to approve the request on the smart mobile device. The prompt may be a screen notification, a vibration, a sound, or some other prompt. At step 515, the authentication engine may receive the user's approval (or disapproval) of the authentication request. At step 517, if the user approved the authentication request, the authentication engine may approve the interaction and transmit the approval/authentication of the user to the application.

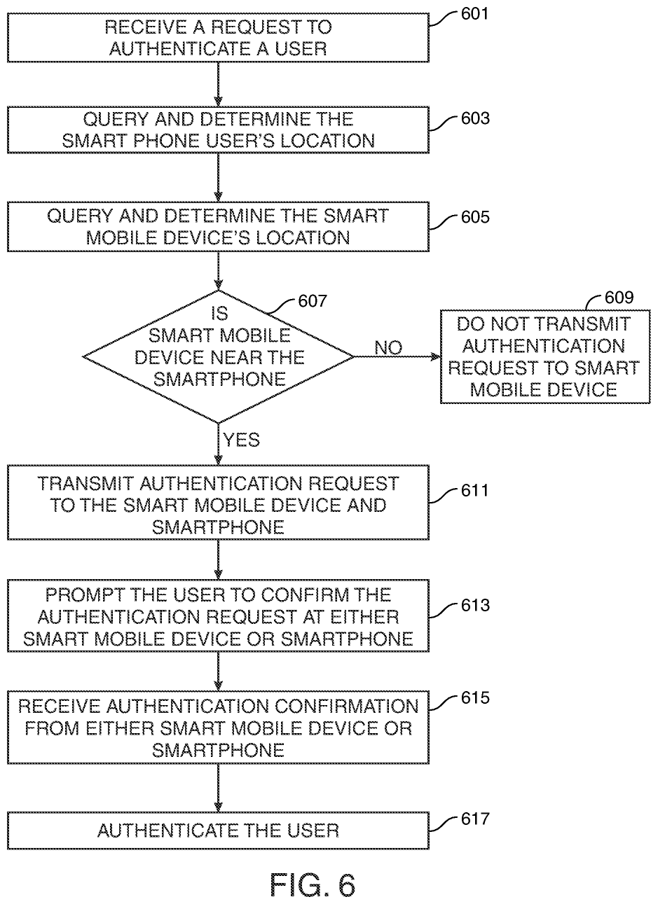

FIG. 6 shows an illustrative flowchart in accordance with principles of the disclosure. Methods may include some or all of the method steps numbered 601 through 617. Methods may include the steps illustrated in FIG. 6 in an order different from the illustrated order. The illustrative method shown in FIG. 6 may include one or more steps performed in other figures or described herein. Steps 601 through 617 may be performed on the apparatus shown in FIGS. 1-4, or other apparatus.

At step 601, an authentication engine may receive authenticate a user. The request may come from a software application or hardware combined with software (such as a smart door lock). The authentication engine may be located on a server, which may be centralized or distributed in various embodiments.

At step 603, the authentication engine may query and determine the location of the user's smartphone. The query may be sent to the application, as it may be assumed the user is in the same location as the application. Alternatively, if the request came from a smartphone application, it may be assumed that the user is in the same location as the smartphone. At step 605, the authentication engine may query and determine the location of a smart mobile device belonging to the user. In an embodiment, the smart mobile device may be a smartwatch.

At step 607, the authentication engine may determine if the smart mobile device is near the user's smartphone, or within a pre-determined distance from the smartphone. If not, at step 609 the authentication engine may only transmit the authentication request to the smartphone and not send it to the smart mobile device. Alternatively, the authentication engine may determine that it cannot authenticate the user at all.

If the smart mobile device is proximate to the user's smartphone, at step 611, the authentication engine may transmit an authentication request to the smart mobile device and the smartphone for the user to approve or disapprove. At step 613, the authentication engine may prompt the user to approve the request on the smart mobile device or the smartphone. The prompt may be a screen notification, a vibration, a sound, or some other prompt. At step 615, the authentication engine may receive the user's approval (or disapproval) of the authentication request from either (or both) the smart mobile device or the smartphone. At step 617, if the user approved the authentication request, the authentication engine may authenticate the user and transmit the authentication of the user to the application.

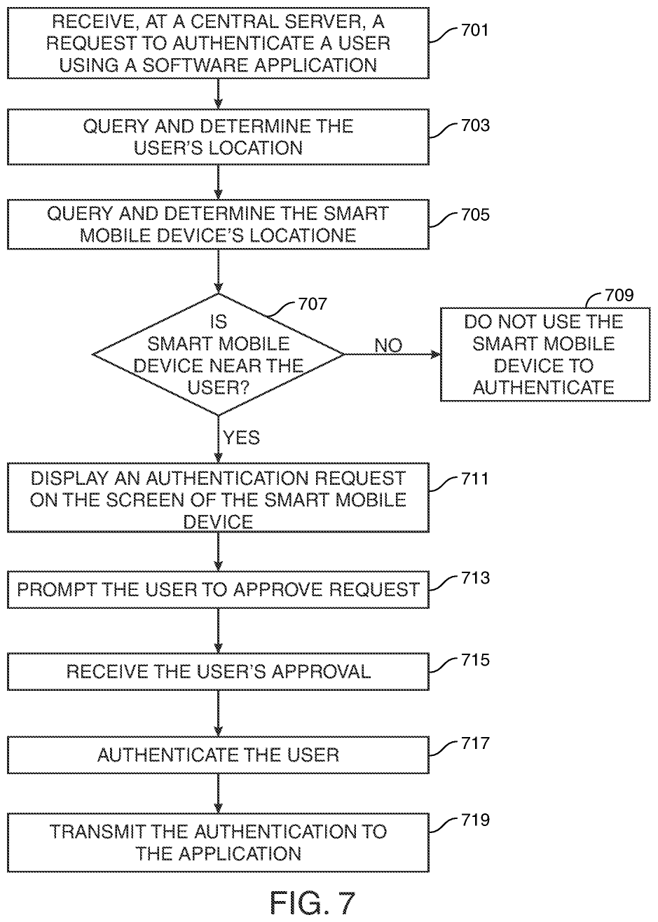

FIG. 7 shows an illustrative flowchart in accordance with principles of the disclosure. Methods may include some or all of the method steps numbered 701 through 717. Methods may include the steps illustrated in FIG. 7 in an order different from the illustrated order. The illustrative method shown in FIG. 7 may include one or more steps performed in other figures or described herein. Steps 701 through 717 may be performed on the apparatus shown in FIGS. 1-4, or other apparatus.

At step 701, an authentication engine may receive a request to authenticate a user interacting with a software application. The request may come from the software application. The authentication engine may be located on a server, which may be centralized or distributed in various embodiments.

At step 703, the authentication engine may query and determine the user's location. The query may be sent to the application, as it may be assumed the user is in the same location as the application. At step 705, the authentication engine may query and determine the location of a smart mobile device belonging to the user.

At step 707, the authentication engine may determine if the smart mobile device is near the user, or within a pre-determined distance from the user. The pre-determined distance may be determined by the authentication engine using AI/ML algorithm(s) or through the parameters of the request. If not, at step 709 the authentication engine may only transmit the authentication request to the application and not send it to the smart mobile device.

If the smart mobile device is proximate to the user, at step 711, the authentication engine may transmit an authentication request to the smart mobile device for the user to approve or disapprove and display the request on a screen of the smart mobile device. In alternative embodiments, the smart mobile device may not have a screen. The screen may be a touchscreen. At step 713, the authentication engine may prompt the user to approve the request on the smart mobile device. In an embodiment, this could be accomplished by the user tapping the touchscreen, such as tapping a checkmark (which may be green) to approve, or an X (which may be red) to disapprove. In various embodiments, the prompt may be a screen notification, a vibration, a sound, or some other prompt.

At step 715, the authentication engine may receive the user's approval (or disapproval) of the authentication request. At step 717, if the user approved the authentication request, the authentication engine may authenticate the user. At step 719, if the user is authentication, the authentication engine may transmit the authentication of the user to the application. Any appropriate communication protocols (wi-fi, cellular signals, Bluetooth, etc.) may be used.

Thus, apparatus and methods for multi-factor authentication with smart mobile device(s) are provided. Persons skilled in the art will appreciate that the present invention can be practiced by other than the described embodiments, which are presented for purposes of illustration rather than of limitation.

What is claimed is:

1. An apparatus for multi-factor authentication, the apparatus comprising:
a central server, the central server comprising:
a communication link;
a processor;
a non-transitory memory configured to store at least:
an operating system; and
an authentication engine that runs on the processor; and
a smart mobile device belonging to a user;
wherein the authentication engine is configured to:
receive a request to approve an interaction in an application by the user, after the user has already been authenticated by the application;
query a location of the user interacting with the application;
query a location of the smart mobile device; and
when the smart mobile device is located proximate to the user:
transmit an authentication request to the smart mobile device;
prompt the user to approve the authentication request;
receive the user's approval of the authentication request; and
approve the interaction.

2. The apparatus of claim 1 wherein the smart mobile device is a smartwatch.

3. The apparatus of claim 1 further comprising a smartphone belonging to the user.

4. The apparatus of claim 3 wherein the application is running on the smartphone.

5. The apparatus of claim 1 wherein the smart mobile device includes a biometric scanner.

6. The apparatus of claim 1 wherein when the smart mobile device is located distantly from the user, transmit an authentication request to the application.

7. The apparatus of claim 1 wherein the smart mobile device is located proximate to the user when the smart mobile device is within three feet of the user.

8. An apparatus for authentication, the apparatus comprising:
a central server, the central server comprising:
a communication link;
a processor;
a non-transitory memory configured to store at least:
an operating system; and
an authentication engine that runs on the processor;
a smartphone belonging to a user; and
a smart mobile device belonging to the user;
wherein the authentication engine is configured to:
receive a request to authenticate the user;
query a location of the smartphone;
query a location of the smart mobile device; and
when the smart mobile device is located within a pre-determined distance to the smartphone:
transmit an authentication request to both the user's smartphone and smart mobile device;
prompt the user to confirm the authentication request on either the user's smartphone or smart mobile device;
receive the authentication confirmation; and
authenticate the user.

9. The apparatus of claim 8 wherein the smart mobile device is a smartwatch.

10. The apparatus of claim 8 wherein the pre-determined distance is 3 feet.

11. The apparatus of claim 8 wherein the smartphone and smart mobile device are wirelessly connected to each other.

12. The apparatus of claim 11 wherein the pre-determined distance is determined by the authentication engine based on the connection type between the smartphone and smart mobile device.

13. The apparatus of claim 11 wherein the wireless connection is comprised of one of the following:
wi-fi;
bluetooth; or
NFC.

14. The apparatus of claim 8 wherein the smart mobile device includes a biometric sensor.

15. The apparatus of claim 14 wherein the user is wearing the smart mobile device and the user approves the authentication request by activating the biometric sensor.

16. A method for multi-factor authentication with a smart mobile device belonging to a user, the method comprising:
receiving, at an authentication engine running on a central server, a request to authenticate the user interacting with an application;
querying, by the authentication engine, a location of the user;
querying, by the authentication engine, a location of the smart mobile device; and
when the smart mobile device is located within a pre-determined distance to the user:
transmitting, from the authentication engine, an authentication request to the smart mobile device;
displaying the authentication request on a screen of the smart mobile device;
prompting the user to approve the authentication request;
receiving, at the authentication engine, the user's approval; and
authenticating the user.

17. The method of claim 16 wherein the smart mobile device is a smartwatch.

18. The method of claim 16 wherein the application is running on a smartphone belonging to the user.

19. The method of claim 18 further comprising querying a location of the smartphone.

20. The method of claim 19 wherein the authentication engine transmits the authentication request to the smart mobile device when the smart mobile device is located within a pre-determined distance to the user and a pre-determined distance to the user's smartphone.
